(19) United States
(12) Patent Application Publication
(10) Pub. No.: US 2024/0331071 A1
(43) Pub. Date: Oct. 3, 2024

(54) MACHINE LEARNING SYSTEMS AND METHODS FOR BUILDING SECURITY RECOMMENDATION GENERATION

(71) Applicant: Tyco Fire & Security GmbH, Neuhausen am Rheinfall (CH)

(72) Inventors: Jason M. Ouellette, Sterling, MA (US); Saravanabavanandam Sadaksharam, Plano, TX (US); Gopal Paripally, North Andover, MA (US); Glenn Holton, Braintree, MA (US); Yohai Falik, Petah Tivka (IL)

(21) Appl. No.: 18/615,819

(22) Filed: Mar. 25, 2024

Related U.S. Application Data
(60) Provisional application No. 63/492,356, filed on Mar. 27, 2023.
(60) Provisional application No. 63/470,749, filed on Jun. 2, 2023.

(51) Int. Cl. G06Q 50/26; G08B 13/04; G08B 13/08; G08B 13/14

(52) U.S. Cl. CPC G06Q 50/265; G08B 13/04; G08B 13/08; G08B 13/1436

(57) ABSTRACT

Systems and methods are disclosed relating to autonomous building security recommendation generation. For example, a method can include receiving, by one or more processors, sensor data from one or more sensors associated with a building system. The method can further include determining, by the one or more processors using a machine learning model and the sensor data, a recommended action for an operator to perform, the machine learning model trained using training data comprising data retrieved from one or more data sources maintained by at least one of a first entity associated with the building system or a second entity associated with the one or more sensors. The method can further include presenting, by the one or more processors using at least one of a display device or an audio output device, a notification corresponding to the recommended action.

### CROSS-REFERENCE TO RELATED APPLICATIONS

The present application claims the benefit of and priority to U.S. Provisional Application No. 63/492,356, filed Mar. 27, 2023, and U.S. Provisional Application No. 63/470,749, filed Jun. 2, 2023, the disclosures of which are incorporated herein by reference in their entireties.

### BACKGROUND

This application relates generally to a building system of a building. This application relates more particularly to machine learning systems and methods for building automation and security systems.

Various interactions between building systems, components of building systems, users, technicians, and/or devices managed by users or technicians can rely on timely generation and presentation of data relating to the interactions, including for performing security, service, or troubleshooting operations. However, it can be difficult to generate the data elements to precisely identify proper response actions or sequences of response actions, as well as options for modified response actions, depending on various factors associated with items of equipment to be serviced and/or locations to be secured, technical issues with the items of equipment, and the availability of timely, precise data to use for supporting the service and security operations.

### SUMMARY

One or more aspects relate to building management systems and methods that implement autonomous building security recommendation generation. At least one aspect relates to a method. The method can include receiving, by one or more processors, sensor data from one or more sensors associated with a building system. The method can further include determining, by the one or more processors using a machine learning model and the sensor data, a recommended action for an operator to perform, the machine learning model trained using training data comprising data retrieved from one or more data sources maintained by at least one of a first entity associated with the building system or a second entity associated with the one or more sensors. The method can further include presenting, by the one or more processors using at least one of a display device or an audio output device, a notification corresponding to the recommended action.

At least one aspect relates to a system. The system can include one or more processors. The one or more processors can receive sensor data from one or more sensors associated with a building system. The one or more processors can determine, using a neural network and the sensor data, a recommended action for an operator to perform, the neural network trained using training data including data retrieved from one or more data sources maintained by at least one of a first entity associated with the building system or a second entity associated with the one or more sensors. The one or more processors can present, using at least one of a display device or an audio output device, a notification corresponding to the recommended action.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for building security applications.

FIG. 2 is a block diagram of an example of a language model-based system for building security applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of implementing generative artificial intelligence architectures and validation processes for machine learning algorithms for building management systems.

FIG. 9 is a block diagram of an example of a machine learning model-based system for building security applications.

FIG. 10 is a flow diagram of a method of implementing generative artificial intelligence architectures and validation processes for machine learning algorithms for building security applications.

### DETAILED DESCRIPTION

Referring generally to the FIGURES, systems and methods in accordance with the present disclosure can implement various systems to precisely generate data relating to operations to be performed for managing building systems and components and/or items of equipment, including security, automation, and heating, ventilation, cooling, and/or refrigeration (HVAC-R) systems and components. For example, various systems described herein can be implemented to more precisely generate data for various applications including, for example and without limitation, electronic or virtual assistance for supporting residents, building managers, technicians responding to service requests, and/or security/safety personnel responding to security/safety events; generating technical reports corresponding to service requests and/or security/safety events; facilitating diagnostics and troubleshooting procedures; and/or recommendations of services to be performed and/or response steps to be taken in response to a given scenario or event. Various such applications can facilitate both asynchronous and real-time security and/or safety response operations, including by generating text data for such applications based on data from disparate data sources that may not have predefined database associations amongst the data sources, yet may be relevant at specific steps or points in time during security and/or safety response operations.

AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data. In some instances, relatively large LLMs, such as LLMs having billions or trillions of parameters, may be less agile in responding to novel queries or applications. In addition, various LLMs may lack transparency, such as to be unable to provide to a user a conceptual/semantic-level explanation of a given output was generated and/or selected relative to other possible outputs.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians and/or security/safety personnel, through relevant service, diagnostic, troubleshooting, repair, and/or security/safety processes.

This can include, for example, receiving data from service, operation, and/or event reports or logs in various formats, including various modalities and/or multi-modal formats (e.g., text, speech, audio, image, and/or video). The system can facilitate automated, flexible report generation, such as by processing information received from security/safety personnel and other users into a standardized format, which can reduce the constraints on how the user submits data while improving resulting reports. The system can couple unstructured event data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, recommendations, and/or fault detection or error detection. The system can receive, from a user responding to a given security, safety, or other event or scenario, feedback regarding the accuracy of the recommended action, as well as feedback regarding how the security/safety personnel actually responded to the event, which can be used to update the recommendation generation model. The system can flexibly generate user interfaces and content to present via user interfaces according to user-specific and other targeted or dynamic factors.

In some instances, significant computational resources (or human user resources) can be required to process data relating to building security and safety process, such as time-series equipment data and/or sensor data, to detect or predict events and provide accurate response recommendations. Systems and methods in accordance with the present disclosure can leverage the efficiency of language models (e.g., GPT-based models or other pre-trained LLMs) in extracting semantic information (e.g., semantic information identifying events, causes of events, responses to events, and other accurate expert knowledge regarding security and safety procedures) from the unstructured data in order to use both the unstructured data and the data relating to equipment operation to generate more accurate outputs regarding security and safety procedures. As such, by implementing language models using various operations and processes described herein, building management, security, and safety systems can take advantage of the causal/semantic associations between the unstructured data and the data relating to specific building security and safety procedures, and the language models can allow these systems to more efficiently extract these relationships in order to more accurately predict targeted, useful information for security and safety applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can enable a generative AI-based wizard interface (e.g., dynamic tool for receiving inputs and/or presenting outputs in a responsive manner to inputs provided by a user). For example, the interface can include user interface and/or user experience features configured to provide a question/answer-based input/output format, such as a conversational interface, that directs users through providing targeted information regarding and adequately responding to various security and safety events within the building. The system can use the interface to present information regarding a variety or recommended response action and procedure steps.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as an event detection application or a response recommendation generator.

In traditional security and safety monitoring systems, sensor and event information overload can lead to a variety of problems, such as operator error (e.g., operators overlooking or ignoring vital alerts, operators performing ineffective responses) and requiring cumbersome processing of largely inconsequential sensor and event information. Furthermore, traditional monitoring systems have not been configured to detect and intervene when an operator (e.g., a security or safety employee) is responding with an incorrect, inappropriate, or sub-optimal response action. The systems and methods described herein solve these problems by employing machine learning models to identify events that require attention and recommend appropriate responses to those events based on a variety of sensor and event information. Further, in some implementations, the systems and methods described herein are further configured to detect, in real-time, that an operator is performing an incorrect, inappropriate, or sub-optimal response to an event and to provide an additional or alternative recommendation to the event.

### I. Machine Learning Models for Building Automation and Security System Operations

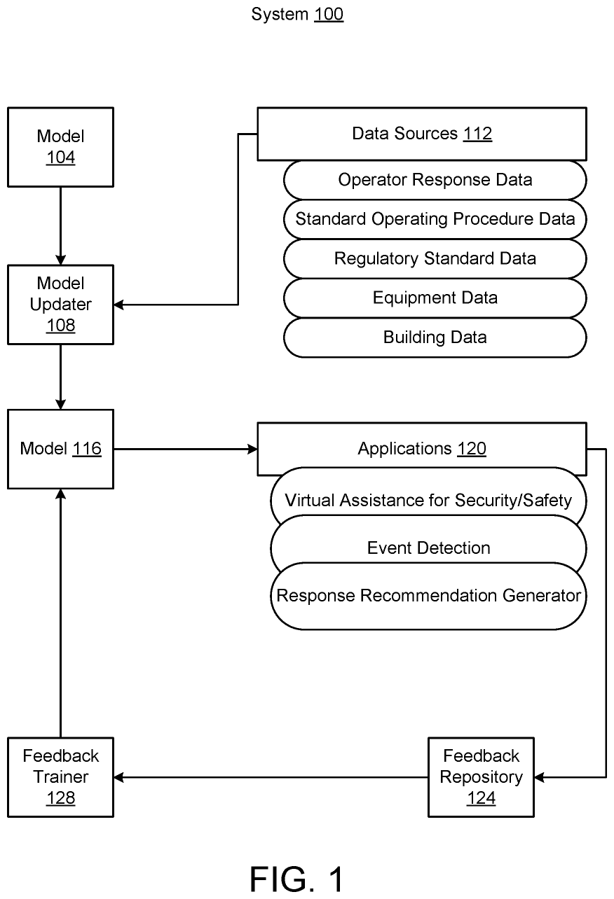

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment automation and security operations, including but not limited to providing real-time, dynamic guidance to users for diagnosing and addressing error or fault conditions in items of equipment, providing targeted recommendations for software upgrades, installation or removal of items of equipment or other modifications to items of equipment or other components of a building system, and/or providing response recommendations to various events occurring or otherwise detected within a building or other area of interest (e.g., security and/or safety response procedure recommendations).

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a sensor system, a home automation (and/or home security) system, a HVAC system, a security system, a video monitoring system, a lighting system, a fire alerting system, any other system that is capable of managing building functions or devices, or any combination thereof. The BMS can include or be coupled with items of equipment, for example and without limitation, any of various sensors such as motion sensors, contact sensors, door sensors, window sensors, temperature sensors, or air quality sensors, alarm devices, heaters, chillers, boilers, air handling units, actuators, refrigeration systems, fans, blowers, heat exchangers, energy storage devices, condensers, valves, or various combinations thereof. The BMS can include or be coupled with one or more controllers and/or use interface devices, such as control panels that can include display and/or audio output devices, as well as any of various user input devices. The BMS can include any of various centralized or decentralized systems (e.g., systems that include edge devices, such as sensors, having at least some processing and/or operational capacity).

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of the controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as technical documents (e.g., service guides) that include both text and image/video information.

In some implementations, the first model 104 can be a generative adversarial network (GAN). As used herein, in some aspects, a GAN can include at least two machine learning models or networks (e.g., two neural networks): a generator that creates new data and a discriminator that evaluates the data. In some instances, the generator and discriminator may work together, with the generator improving its outputs based on the feedback it receives from the discriminator until the generator generates content that is indistinguishable from real data. For example, in some implementations, a first sub-model may be a discriminator based on operating policies and a second sub-model may be a generator based on historic event and response information; in various implementations, various combinations of data may be used to configure one or more both of the generator and discriminator. In some implementations, the generator determines a first output responsive to an input (e.g., where the input is retrieved from a training data example), the discriminator determines or identifies a second output (e.g., a second output also corresponding to the input), and the system 100 evaluates the first output relative to the second output (e.g., determines whether a difference between the first output and the second output is greater or less than a target threshold) to determine whether to modify the generator (e.g., responsive to the difference being greater than the threshold). In various implementations, the first sub-model may be used to train the second sub-model. Additionally, in some implementations, the GAN model may be trained using reinforcement learning and/or a reward model.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to security, automation, and/or building management systems. For example, the training data can include examples of sensor data, event data, security response data, video processing data, computer vision detection data, object detection data, HVAC-R data, operating manuals, technical data sheets, building information model (BIM) data, standard operating procedures, configuration settings, regulatory standard data, operator response standard operating procedure data, operating setpoints, diagnostic guides, troubleshooting guides, user reports, technician reports, or various combinations thereof. In some implementations, the training data used to configure the first model 104 includes at least some publicly accessible data, such as data retrievable via the Internet. It should be appreciated that any publicly accessible data utilized to configure the first model 104 may be limited to generic data that is widely applicable to a variety of input data, but not necessarily specific to a particular building associated with the system 100. Accordingly, as will be discussed below, in some instances, the model updater 108 may utilize building- and/or product-specific training data to provide a more robust and usefully trained model (e.g., the second model 116) for use by operators, employees, security personnel, etc. within the particular building or area of interest for which the system 100 is implemented.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include security, device operation, equipment automation, sensor, or HVAC-R data in any of text, speech, audio, image, or video data, or various combinations thereof, such as data associated with any of various components and procedures described herein including but not limited to installation, operation, configuration, security, repair, servicing, diagnostics, and/or troubleshooting of components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers, or is in a predetermined format, such as a database or tabular format). The unstructured data can include one or more data elements that are not in a predetermined format (e.g., are not assigned to fields, or labeled with or assigned with identifiers, that are indicative of a characteristic of the one or more data elements). The data sources 112 can include semi-structured data, such as data assigned to one or more fields that may not specify at least some characteristics of the data, such as data represented in a report having one or more fields to which freeform data is assigned (e.g., a report having a field labeled “describe the item of equipment” in which text or user input describing the item of equipment is provided). The data sources 112 can include data that is incomplete,

For example, using the first model 104 and/or second model 116 to process the data can allow the system 100 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 100 to predict resources to use for performing service as well as when to request service.

The data sources 112 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 112 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 112 can include parts data, including but not limited to parts usage and sales data. For example, the data sources 112 can indicate various parts associated with installation or repair of items of equipment. The data sources 112 can indicate tools for performing service and/or installing parts.

In some implementations, the data sources 112 can include operator response data, including but not limited to indications of steps taken by operators in response to various events or other activities within the building. In some implementations, the data sources 112 can include standard operating procedure data, including but not limited to various standard operating procedure data associated with responding to events and/or activities within the building. In some implementations, the data sources 112 can include regulatory standard data, including but not limited to various event response procedures required and/or recommended by various regulatory authorities (e.g., OSHA).

The system 100 can include, with the data of the data sources 112, labels to facilitate cross-reference between items of data that may relate to common items of equipment, manufacturers, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., engineering data, operational data, and service data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site (e.g., a building) at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can enable the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by mobile applications, enterprise management software systems, employee, or other user applications (e.g., applications that relate to BMS functionality such as temperature control, user preferences, conference room scheduling, etc.), equipment portals that provide data regarding items of equipment, or various combinations thereof.

The applications 120 can include user interfaces, dashboards, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a security employee, a manager, a service technician, a safety employee, etc., and generate reports in a standardized format, such as a user-specific format. This can allow, for example, security and/or safety personnel to automatically, and flexibly, generate customer-ready reports after security and/or safety incidents without requiring strict input by the security and/or safety personnel or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for information from users such as service technicians, facility managers, security and/or safety personnel, or other occupants, and provide the received responses to at least one of the second model 116 to determine appropriate recommended actions in response to a variety of scenarios. The virtual assistant application 120 can use requests for information such as for unstructured text by which the user describes characteristics of an event occurring within the building; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that there has been a forced door event, the system 100 can request, via the virtual assistant application 120, information associated with security and/or safety personnel response steps taken so far and/or for additional information regarding the space where the forced door event occurred.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a security and/or safety personnel user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, security and/or safety personnel, etc., follow the provided steps for responding to the event, did the user discontinue providing inputs to the virtual assistant application 120, etc.), such as to enable the system 100 to update the information generated by the second model 116 for the virtual assistant application 120 according to the engagement. In some implementations, the system 100 can use the second model 116 to detect sentiment of the user of the virtual assistant application 120, and update the second model 116 according to the detected sentiment, such as to improve the experience provided by the virtual assistant application 120.

In some implementations, the applications 120 can include at least one document writer application 120, such as a technical document writer. The document writer application 120 can facilitate preparing structured (e.g. form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment, including to perform modifications such as hardware or software additions, removals, updates, or various combinations thereof.

In some implementations, the applications 120 can include an event detection application 120. The event detection application 120 can process inputs such as information regarding the a given space within a building, using one or more second models 116 (e.g., models trained using parts data from the data sources 112), to whether an event (e.g., a forced door event, a motion sensor trigger, a glass break event, a gunshot event, an access rejection, one or more cameras being in an offline state, or one or more cameras being in an out of focus state) has occurred.

In some implementations, the applications 120 can include a response recommendation generator application 120. The response recommendation generator application 120 can process inputs such as information regarding a given space within a building and/or a detected event within that space, using one or more second models 116 (e.g., models trained using parts data from the data sources 112), to determine a recommendation of one or more response steps for an operator (e.g., a security or safety employee) to take in response to a given scenario or event occurring within the space.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

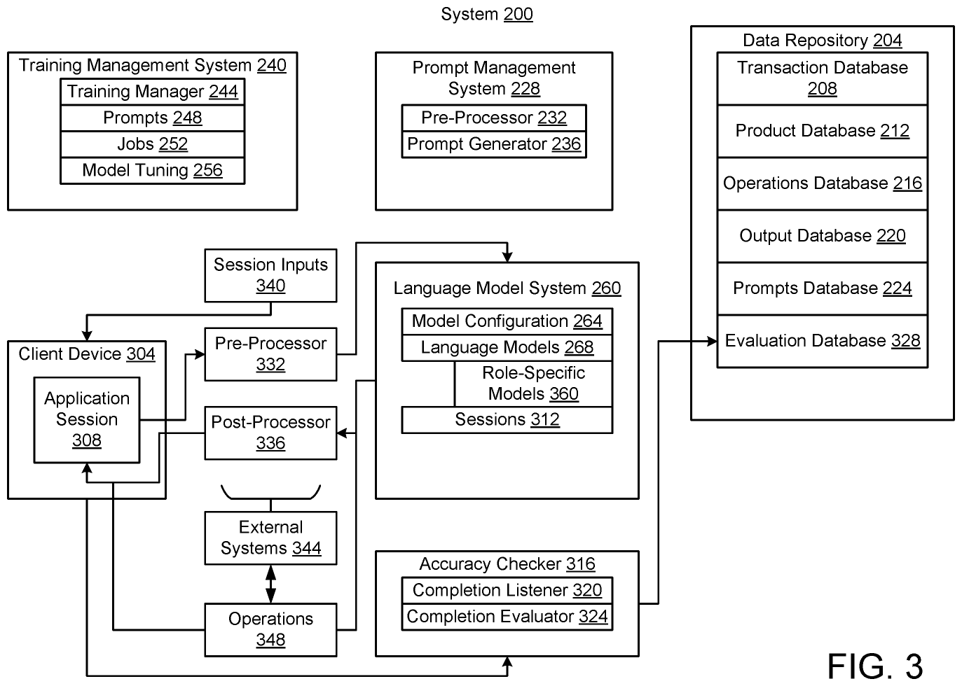

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### II. System Architectures for Generative AI Applications for Building Security, Automation, and Management Systems

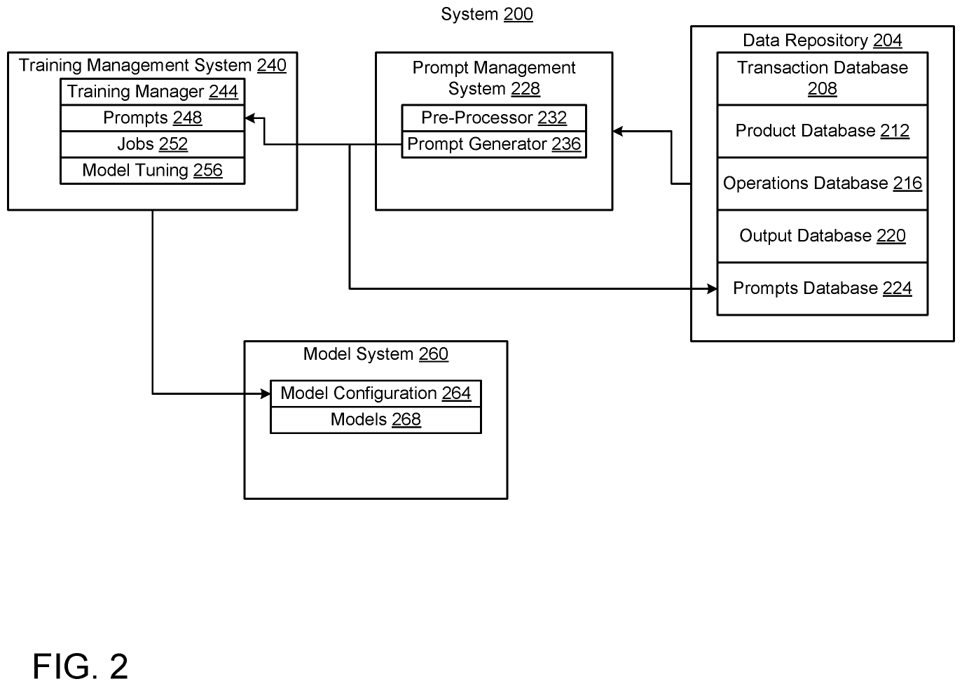

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to enable generative AI applications for building automation, security, and management systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used to address various events or conditions; sales data indicating various transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 228, and determine training data elements that include examples of input and outputs for generation by machine learning models, such as a training data element that includes a prompt and a completion corresponding to the prompt, based on the data from the data repository 228.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a resident, homeowner, or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which may include at least one of the first prompt or the first completion concatenated to the second prompt), and provide the second completion to the application session 308.

In some implementations, the application session 308 maintains a session state regarding the application session 308. The session state can include one or more prompts received by the application session 308, and can include one or more completions received by the application session 308 from the model system 260. The session state can include one or more items of feedback received regarding the completions, such as feedback indicating accuracy of the completion.

The system 200 can include or be coupled with one or more session inputs 340 or sources thereof. The session inputs 340 can include, for example and without limitation, location-related inputs, such as identifiers of an entity managing an item of equipment or a building or building management system, a jurisdiction (e.g., city, state, country, etc.), a language, or a policy or configuration associated with operation of the item of equipment, building, or building management system. The session inputs 340 can indicate an identifier of the user of the application session 308. The session inputs 340 can include data regarding items of equipment or building management systems, including but not limited to operation data or sensor data. The session inputs 340 can include information from one or more applications, algorithms, simulations, neural networks, machine learning models, or various combinations thereof, such as to provide analyses, predictions, or other information regarding items of equipment. The session inputs 340 can data from or analogous to the data of the data repository 204.

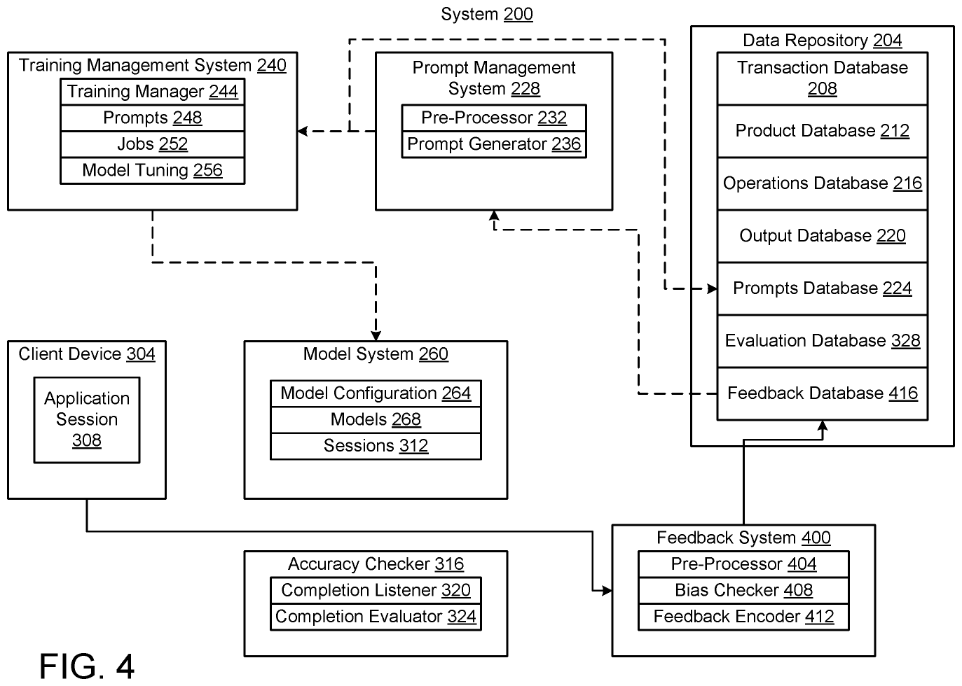

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268. The sessions database 312 can include one or more session states of the application session 308.

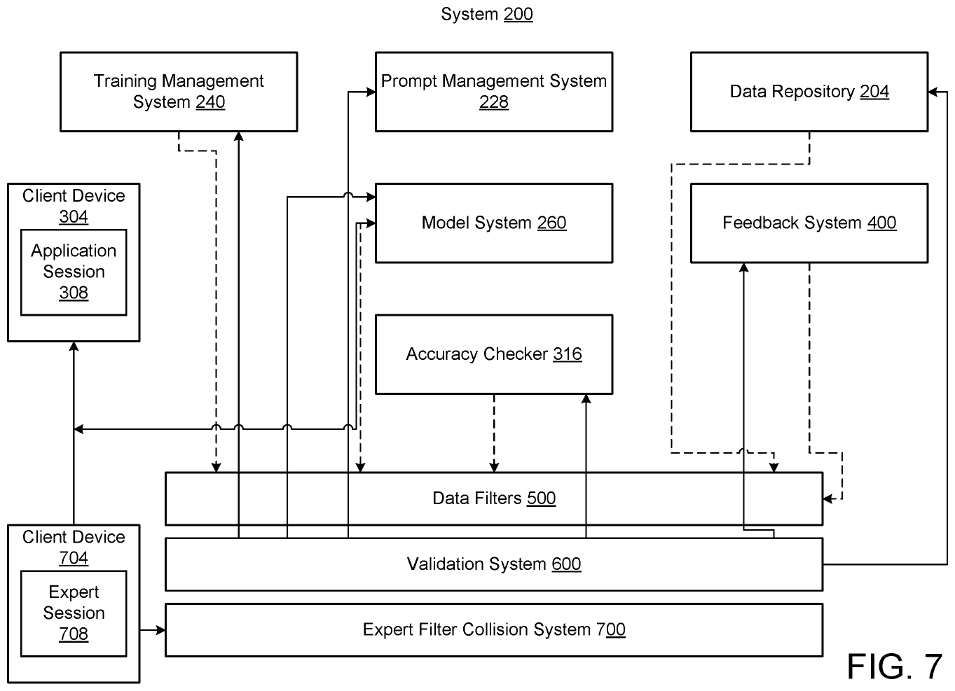

As depicted in FIG. 3, the system 200 can include at least one pre-processor 332. The pre-processor 332 can evaluate the prompt according to one or more criteria and pass the prompt to the model system 260 responsive to the prompt satisfying the one or more criteria, or modify or flag the prompt responsive to the prompt not satisfying the one or more criteria. The pre-processor 332 can compare the prompt with any of various predetermined prompts, thresholds, outputs of algorithms or simulations, or various combinations thereof to evaluate the prompt. The pre-processor 332 can provide the prompt to an expert system (e.g., expert system 700 described with reference to FIG. 7) for evaluation. The pre-processor 332 (and/or post-processor 336 described below) can be made separate from the application session 308 and/or model system 260, which can modularize overall operation of the system 200 to facilitate regression testing or otherwise enable more effective software engineering processes for debugging or otherwise improving operation of the system 200. The pre-processor 332 can evaluate the prompt according to values (e.g., numerical or semantic/text values) or thresholds for values to filter out of domain inputs, such as inputs targeted for jail-breaking the system 200 or components thereof, or filter out values that do not match target semantic concepts for the system 200.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 320 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

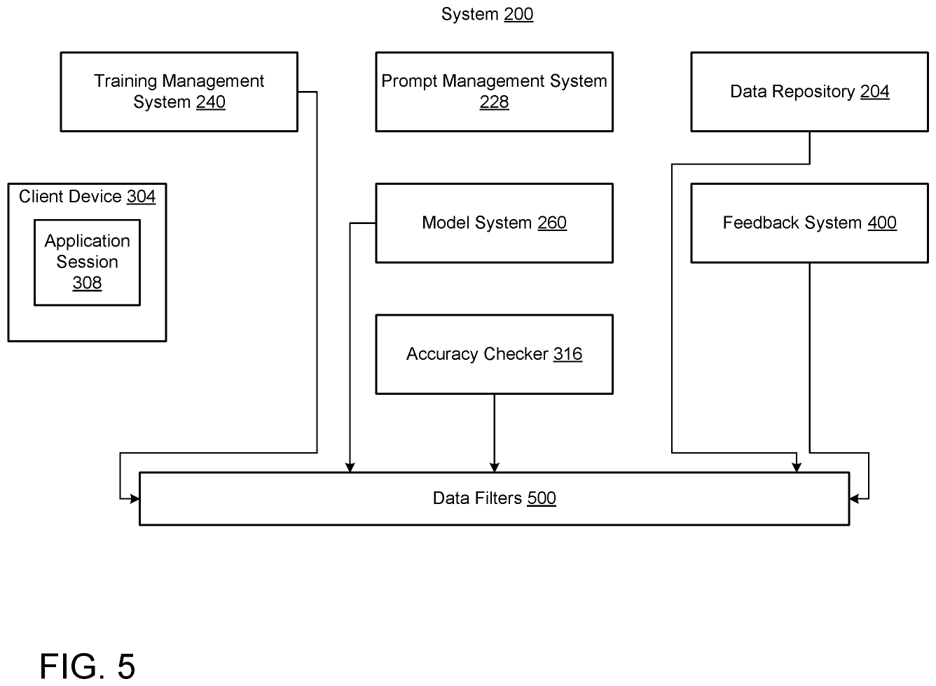

The accuracy checker 316 can include or be coupled with at least one post-processor 336. The post-processor 336 can perform various operations to evaluate, validate, and/or modify the completions generated by the model system 260. In some implementations, the post-processor 336 includes or is coupled with data filters 500, validation system 600, and/or expert system 700 described with reference to FIGS. 5-7. The post-processor 336 can operate with one or more of the accuracy checker 316, external systems 344, operations data 348, and/or role models 360 to query databases, knowledge bases, or run simulations that are granular, reliable, and/or transparent.

Referring further to FIG. 3, the system 200 can include or be coupled with one or more external systems 344. The external systems 344 can include any of various data sources, algorithms, machine learning models, simulations, internet data sources, or various combinations thereof. The external systems 344 can be queried by the system 200 (e.g., by the model system 260) or the pre-processor 332 and/or post-processor 336, such as to identify thresholds or other baseline or predetermined values or semantic data to use for validating inputs to and/or outputs from the model system 260. The external systems 344 can include, for example and without limitation, documentation sources associated with an entity that manages items of equipment.

The system 200 can include or be coupled with operations data 348. The operations data 348 can be part of or analogous to one or more data sources of the data repository 204. The operations data 348 can include, for example and without limitation, data regarding real-world operations of building management systems and/or items of equipment, such as changes in building policies, building states, ticket or repair data, results of servicing or other operations, performance indices, or various combinations thereof. The operations data 348 can be retrieved by the application session 308, such as to condition or modify prompts and/or requests for prompts on operations data 348.

### Role-Specific Machine Learning Models

As depicted in FIG. 3, in some implementations, the models 268 can include or otherwise be implemented as one or more role-specific models 360. The models 360 can be configured using training data (and/or have tuned hyperparameters) representative of particular tasks associated with generating accurate completions for the application sessions 308 such as to perform iterative communication of various language model job roles to refine results internally to the model system 260 (e.g., before/after communicating inputs/outputs with the application session 308), such as to validate completions and/or check confidence levels associated with completions. By incorporating distinct models 360 (e.g., portions of neural networks and/or distinct neural networks) configured according to various roles, the models 360 can more effectively generate outputs to satisfy various objectives/key results.

For example, the role-specific models 360 can include one or more of an author model 360, an editor model 360, a validator model 360, or various combinations thereof. The author model 360 can be used to generate an initial or candidate completion, such as to receive the prompt (e.g., via pre-processor 332) and generate the initial completion responsive to the prompt. The editor model 360 and/or validator model 360 can apply any of various criteria, such as accuracy checking criteria, to the initial completion, to validate or modify (e.g., revise) the initial completion. For example, the editor model 360 and/or validator model 360 can be coupled with the external systems 344 to query the external systems 344 using the initial completion (e.g., to detect a difference between the initial completion and one or more expected values or ranges of values for the initial completion), and at least one of output an alert or modify the initial completion (e.g., directly or by identifying at least a portion of the initial completion for the author model 360 to regenerate). In some implementations, at least one of the editor model 360 or the validator model 360 are tuned with different hyperparameters from the author model 360, or can adjust the hyperparameter(s) of the author model 360, such as to facilitate modifying the initial completion using a model having a higher threshold for confidence of outputted results responsive to the at least one of the editor model 360 or the validator model 360 determining that the initial completion does not satisfy one or more criteria. In some implementations, the at least one of the editor model 360 or the validator model 360 is tuned to have a different (e.g., lower) risk threshold than the author model 360, which can allow the author model 360 to generate completions that may fall into a greater domain/range of possible values, while the at least one of the editor model 360 or the validator model 360 can refine the completions (e.g., limit refinement to specific portions that do not meet the thresholds) generated by the author model 360 to fall within appropriate thresholds (e.g., rather than limiting the threshold for the author model 360).

For example, responsive to the validator model 360 determining that the initial completion includes a value (e.g., setpoint to meet a target value of a performance index) that is outside of a range of values validated by a simulation for an item of equipment, the validator model 360 can cause the author model 360 to regenerate at least a portion of the initial completion that includes the value; such regeneration may include increasing a confidence threshold for the author model 360. The validator model 360 can query the author model 360 for a confidence level associated with the initial completion, and cause the author model 360 to regenerate the initial completion and/or generate additional completions responsive to the confidence level not satisfying a threshold. The validator model 360 can query the author model 360 regarding portions (e.g., granular portions) of the initial completion, such as to request the author model 360 to divide the initial completion into portions, and separately evaluate each of the portions. The validator model 360 can convert the initial completion into a vector, and use the vector as a key to perform a vector concept lookup to evaluate the initial completion against one or more results retrieved using the key.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 400. The pre-processor 400 can perform any of various operations to modify the feedback for further processing. For example, the pre-processor 400 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

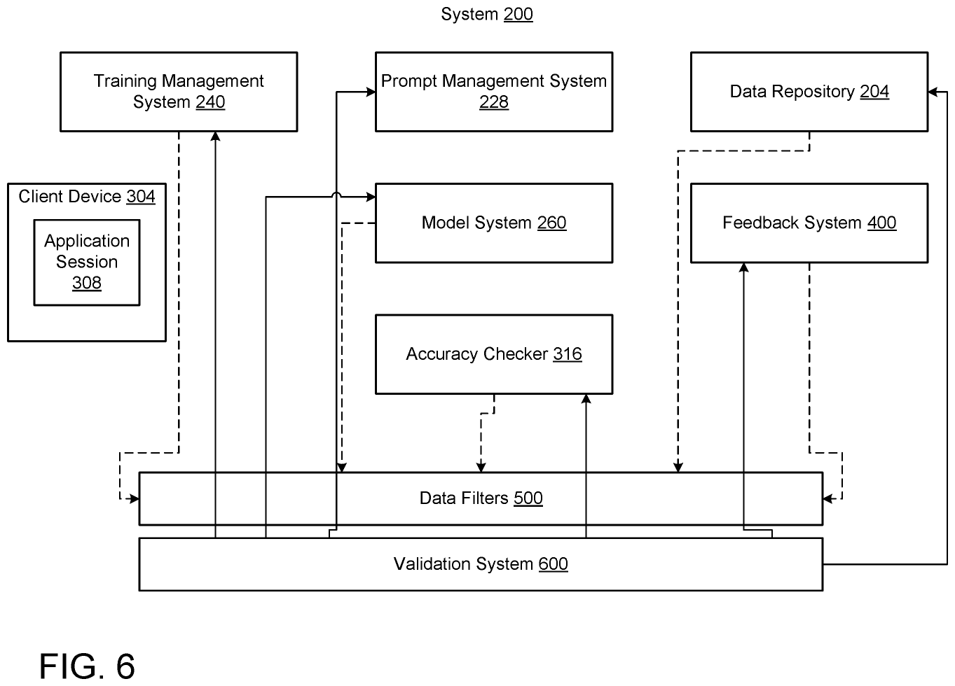

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can enable the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can enable the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some implementations, the system 200 determines or receives the thresholds using models or simulations of items of equipment, such as sensor models, operation models, plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some implementations, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can enable the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can enable the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can enable the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert session 700 can enable functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some implementations, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 708 to selectively identify experts to use for monitoring and validating the data.

In some implementations, the expert system 700 facilitates a communication session regarding the data, between the application session 308 and the expert session 708. For example, the expert session 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some implementations, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to enable the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application No. 202341008712, filed Feb. 10, 2023, the disclosures of which are incorporated herein by reference in their entireties.

### III. Generative AI-Based Systems and Methods for Building Systems

As described above, systems and methods in accordance with the present disclosure can use machine learning models, including LLMs and other generative AI models, to ingest data regarding building automation, security, and/or management systems and equipment in various unstructured and structured formats, and generate completions and other outputs targeted to provide useful information to users. Various systems and methods described herein can use machine learning models to support applications for presenting data with high accuracy and relevance.

### Implementing GAI Architectures for Building Management Systems

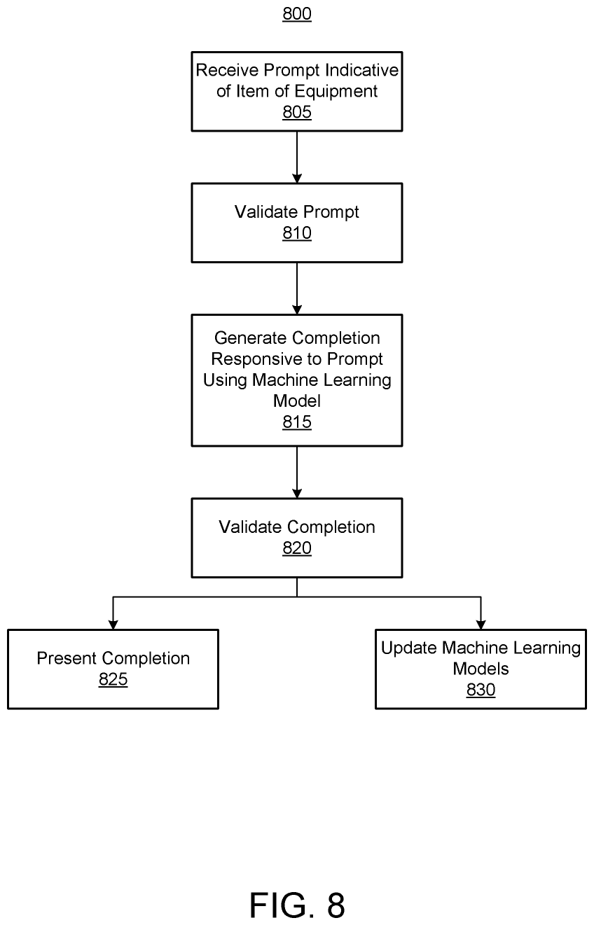

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures. As described with respect to various aspects of the system 200 (e.g., with reference to FIGS. 3-7), the method 800 can implement operations to facilitate more accurate, precise, and/or timely determination of completions to prompts from users regarding items of equipment, such as to incorporate various validation systems to improve accuracy from generative models.

At 805, a prompt can be received. The prompt can be received using a user interface implemented by an application session of a client device. The prompt can be received in any of various data formats, such as text, audio, speech, image, and/or video formats. The prompt can be indicative of an item of equipment, such as a condition of the equipment (e.g., an error detected or fault condition) or a building automation security, and/or management system or component thereof. The prompt can indicate a request for a service to perform for the item of equipment. The prompt can indicate one or more characteristics of the item of equipment. In some implementations, the application session provides a conversational interface or chatbot for receiving the prompt, and can present queries via the application to request information for the prompt. For example, the application session can determine that the prompt indicates a type of equipment, and can request information regarding expected issues regarding the equipment (e.g., via iterative generation of completions and communication with machine learning models).

At 810, the prompt is validated. For example, criteria such as one or more rules, heuristics, models, algorithms, thresholds, policies, or various combinations thereof can be evaluated using the prompt. The criteria can be evaluated to determine whether the prompt is appropriate for the item of equipment. In some implementations, the prompt can be evaluated by a pre-processor that may be separate from at least one of the application session or the machine learning models. In some implementations, the prompt can be evaluated using any one or more accuracy checkers, data filters, simulations regarding operation of the item of equipment, or expert validation systems; the evaluation can be used to update the criteria (e.g., responsive to an expert determining that the prompt is valid even if the prompt includes information that does not satisfy the criteria, the criteria can be updated to be capable of being satisfied by the information of the prompt). In some implementations, the prompt is modified according to the evaluation; for example, a request can be presented via the application session for an updated version of the prompt, or the pre-processor can modify the prompt to make the prompt satisfy the one or more criteria. The prompt can be converted into a vector to perform a lookup in a vector database of expected prompts or information of prompts to validate the prompt.

At 815, at least one completion is generated using the prompt (e.g., responsive to validating the prompt). The completion can be generated using one or more machine learning models, including generative machine learning models. For example, the completion can be generated using a neural network comprising at least one transformer, such as GPT model. The completion can be generated using image/video generation models, such as GAN and/or diffusion models. The completion can be generated based on the one or more machine learning models being configured (e.g., trained, updated, fine-tuned, etc.) using training data examples representative of information for items of equipment, including but not limited to unstructured data or semi-structured data such as service technician reports, operating manuals, technical data sheets, etc. Prompts can be iteratively received and completions iteratively generated responsive to the prompts as part of an asynchronous and/or conversational communication session.

In some implementations, generating the prompt comprises using a plurality of machine learning models, which may be configured in similar or different manners, such as by using different training data, model architectures, parameter tuning or hyperparameter fine tuning, or various combinations thereof. In some implementations, the machine learning models are configured in a manner representative of various roles, such as author, editor, validation, external data comparison, etc. roles. For example, a first machine learning model can operate as an author model, such as to have relatively fewer/lesser criteria for generating an initial completion responsive to the prompt, such as to require relatively lower confidence levels or risk criteria. A second machine learning model can be configured to have relatively greater/higher criteria, such as to receive the initial completion, process the initial completion to detect one or more data elements (e.g., tokens or combinations of tokens) that do not satisfy criteria of the second machine learning model, and output an alert or cause the first machine learning model to modify the initial completion responsive to the valuation. For example, the editor model can identify a phrase in the initial completion that does not satisfy an expected value (e.g., expected accuracy criteria determined by evaluating the prompt using a simulation), and can cause the first machine learning model to provide a natural language explanation of factors according to which the initial completion was determined, such as to present such explanations via the application session. The machine learning models can evaluate the completions according to bias criteria. The machine learning models can store the completions and prompts as data elements for further configuration of the machine learning models (e.g., positive/negative examples corresponding to the prompts).

At 820, the completion can be validated. The completion can be validated using various processes described for the machine learning models, such as by comparing the completion to any of various thresholds or outputs of databases or simulations. For example, the machine learning models can configure calls to databases or simulations for the item of equipment indicated by the prompt to validate the completion relative to outputs retrieved from the databases or simulations. The completion can be validated using accuracy checkers, bias checkers, data filters, or expert systems.

At 825, the completion is presented via the application session. For example, the completion can be presented as any of text, speech, audio, image, and/or video data to represent the completion, such as to provide an answer to a query represented by the prompt regarding an item of equipment or building management system. The completion can be presented via iterative generation of completions responsive to iterative receipt of prompts. The completion can be present with a user input element indicative of a request for feedback regarding the completion, such as to enable the prompt and completion to be used for updating the machine learning models.

At 830, the machine learning model(s) used to generate the completion can be updated according to at least one of the prompt, the completion, or the feedback. For example, a training data element for updating the model can include the prompt, the completion, and the feedback, such as to represent whether the completion appropriately satisfied a user's request for information regarding the item of equipment. The machine learning models can be updated according to indications of accuracy determined by operations of the system such as accuracy checking, or responsive to evaluation of completions by experts (e.g., responsive to selective presentation and/or batch presentation of prompts and completions to experts).

### System for Autonomous Event Response Recommendation

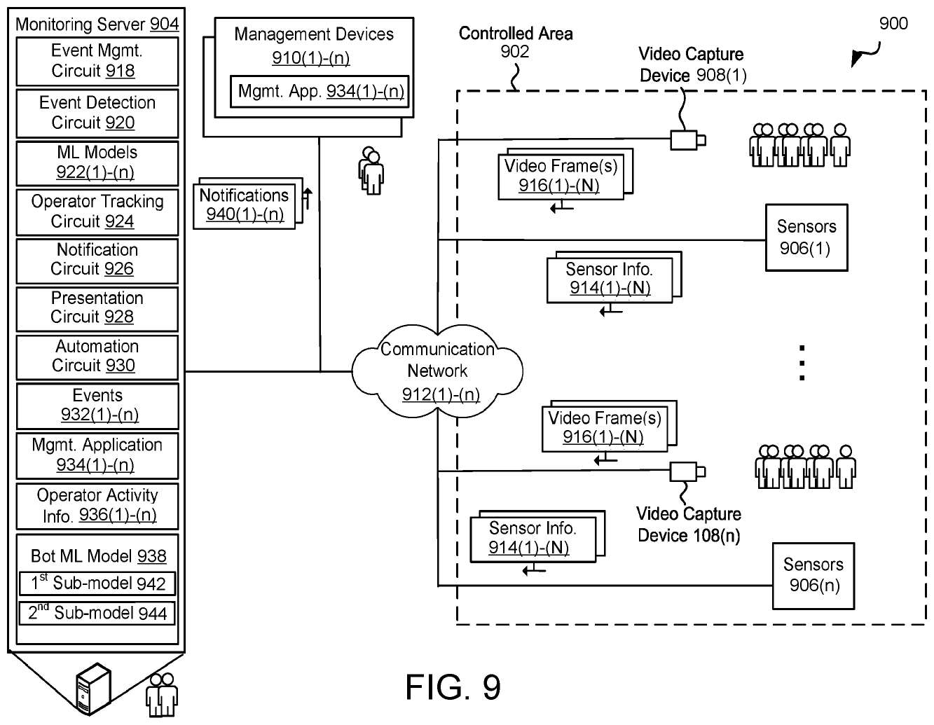

FIG. 9 depicts an event monitoring system 900. The event monitoring system 900 can monitor activity within and/or around a controlled area 902 (e.g., a space within a building or other area of interest), and generate security response recommendations based on the monitored activity. For example, event monitoring system 900 is configured to capture sensor information and video feed data, determine event information from the sensor information and the video feed data, and analyze the event information to generate a security response to the event information. The event monitoring system 900 may track activity of a human operator, identify a proposed response of the human operator, and recommend the security response (e.g., as a different or alternative response to the proposed response). The event monitoring system 900 can automatically initiate performance or perform one or more steps of the security response.

As illustrated in FIG. 9, the event monitoring system 900 may include an event monitoring server 904, one or more sensors 906(1)-(n), one or more video capture devices 908(1)-(n), one or more management devices 910(1)-(n), and/or one or more communication networks 912(1)-(n). The one or more sensors 906(1)-(n) and/or the one or more video capture device 908(1)-(n) may be positioned in different areas of the controlled area 902. Although FIG. 9 illustrates that a location within the controlled area 902 may have a sensor 906 and a video capture device 908, a location within the controlled area 902 may have any number of sensors 906 or video capture devices 908. In some implementations, a communication network 912 may include a plain old telephone system (POTS), a radio network, a cellular network, an electrical power line communication system, one or more of a wired and/or wireless private network, personal area network, local area network, wide area network, and/or the Internet. In some implementations, the event monitoring server 904, the one or more sensors 906(1)-(n), the one or more video capture devices 908(1)-(n), and the one or more management devices 910(1)-(n) may be configured to communicate via the communication networks 912(1)-(n).

In some implementations, the one or more sensors 906(1)-(n) may capture sensor information 914 and transmit the sensor information 914 to the event monitoring server 904 via the communications network 912(1)-(n). The one or more sensors 906(1)(n) can include lidar sensors, radar sensors, infra-red sensors, loudness sensors, audio capture devices, occupancy sensors, environmental sensors, door sensors, entry sensors, exit sensors, people counting sensors, temperature sensors, liquid sensors, motion sensors, light sensors, gas sensors, location sensors, carbon monoxide sensors, smoke sensors, pulse sensors, etc. In some aspects, the video capture devices 908(1)-(n) may capture one or more video frames 916(1)-(n) of activity within the controlled area 902, and transmit the one or more video frames 916(1)-(n) to the event monitoring server 904 via the communications network 912(1)-(n). The management devices 910(1)(n) can include smartphones and computing devices, Internet of Things (IoT) devices, video game systems, robots, process automation equipment, control devices, vehicles, transportation equipment, virtual and augmented reality (VR and AR) devices, industrial machines, audio alarm devices, a strobe or flashing light devices, etc.

The event monitoring server 904 may be configured to monitor the controlled area 902 and generate AI driven responses to the monitored activity. As illustrated in FIG. 9, the event monitoring server 904 may include an event management circuit 918, an event detection circuit 920, one or more ML models 922(1)-(n), an operator tracking circuit 924, a notification circuit 926, a presentation circuit 928, and an automation circuit 930. In some aspects, the event detection circuit 920 may identify and/or detect events 932(1)-(n) based upon the sensor information 914 received by the event management circuit 918 from the one or more sensors 906(1)-(n) and/or the one or more video frames 916(1)-(n). The sensor information 914 may identify events 932(1)-(n) detected at the one or more sensors 906(1)-(n). For instance, the event detection circuit 920 may receive an event indicating that a door has been forced open, a door has been held opened (e.g., a door has been held open for a period of time above a predefined threshold), access to an entryway has been denied, access to an entryway has been granted, badge access to an entryway has been denied, badge access to an entryway has been granted, identification of a person of interest, use of a suspicious badge, suspicious operator patterns, suspicious credential usage, suspicious badge creation patterns, multiple failures to authenticate using a physical credential (e.g., badge), hardware communication failure, and/or multiple occurrences of at least one of the preceding event types in a common location. Suspicious badge usage may include a number of badge rejections above a predefined threshold, abnormal usage based on the normal activity of the badge holder (e.g., badge use at a location infrequently accessed by the badge holder, badge use during a time period not associated with typical usage by the badge holder), a number of badge rejections above a predefined threshold within a predefined period of time at a same location, a number of badge rejections above a predefined threshold at two or more locations within a predefined distance of each other, a number of badge rejections above a predefined threshold by a particular badge holder, and/or a number of badge rejections above a predefined threshold having a particular reason for denial at a particular location and/or during a particular period in time.

In some implementations, the event detection circuit 920 may detect an event based upon the sensor information 914 received from the one or more sensors 906(1)-(n). The event detection circuit 920 may receive a sensor reading from a sensor 906, and generate an event 932 indicating that a door has been forced open, a door has been held open, access to an entryway has been denied, access to an entryway has been granted, identification of a person of interest, use of a suspicious badge, and/or hardware communication failure. As another example, the event detection circuit 920 may receive a sensor reading including a temperature of a location within the controlled area 902 from a sensor 906, and generate a fire event. In some aspects, the event detection circuit 920 may employ the one or more machine-learning (ML) models 922(1)-(n) to identify and/or detect events 932(1)-(n) based upon the sensor information 914. The ML models 922(1)-(n) may include any of the various artificial intelligence and/or machine learning models described herein.

In some implementations, the event detection circuit 920 may detect an event based upon the one or more video frames 916(1)-(n). The event detection circuit 920 may detect faces in the one or more video frames 916(1)(n) received from the video capture devices 908(1)-(n), and generate an event 932 based on the detected faces. For instance, the event detection circuit 920 may identify a face within the one or more video frames 916(1) based at least in part on the one or more ML models 922 configured to identify facial landmarks within a video frame. The event detection circuit 920 may track objects between the one or more video frames 916(1)-(n), and generate an event 932 based upon the detected movement. For example, the event detection circuit 920 may generate tracking information indicating movement of a person between the one or more video frames 916(1)-(n). In some aspects, the event detection circuit 920 may determine a bounding box for the person and track the movement of the bounding box between successive one or more video frames 916. The event detection circuit 920 may employ the one or more ML models 922(1)-(n) to generate the bounding boxes corresponding to people within the controlled area 902. Further, the event detection circuit 920 may determine path information for people within the controlled area 902 based at least in part on the tracking information, and generate an event 932 based upon the path information. As an example, the event detection circuit 920 may generate path information indicating the journey of the person throughout the controlled area 902 based upon the movement of the person between successive video frames 916. The event detection circuit 920 may be able to determine a wait time indicating the amount of time a person has spent in a particular area, and an engagement time indicating the amount of time a person has spent interacting another person and/or object. Further, the event detection circuit 920 may be configured to generate a journey representation indicating the journey of a person through the controlled area 902 with information indicating the duration of the journey of the person within the controlled area 902, and the amount of time the person spent at different areas within the controlled area 902. The event detection circuit 920 may generate an event 932 based upon the journey representation. In some aspects, the event detection circuit 920 may determine the wait time and the engagement time based at least in part on bounding boxes. For instance, the event detection circuit 920 may determine a first bounding box corresponding to a person and a second bounding box corresponding to another person and/or an object. The event detection circuit 920 may monitor the distance between the first bounding box and the second bounding box. In some aspects, when the distance between the first bounding box and the second bounding box as determined by the event detection circuit 920 is less than a threshold, the event detection circuit 920 may determine that a person is engaged with another person and/or an object. The event detection circuit 920 may further rely on body language and gaze to determine whether a person is engaged with another person and/or an object. Further, the event detection circuit 920 may determine path information based at least in part on the one or more ML models 922(1)-(n) configured to generate and track bounding boxes.

The event detection circuit 920 may determine the amount of people that enter and exit the controlled area 902 based on the one or more video frames 916(1)-(n). In particular, the one or more of the video capture devices 908(1)-(n) may be positioned to capture activity by entry ways and exits of the controlled area 902. In some aspects, the event detection circuit 920 may identify people in the one or more video frames 916(1)-(n), and determine the direction of the movement of the people and whether the people have traveled past predefined locations corresponding to entry to and exit from the controlled area 902. The event detection circuit 920 may determine one or more attributes of people within the controlled area 902 based on the one or more video frames 916(1)-(n) received from the video capture devices 908(1)-(n), and generate an event based upon the one or more attributes of the people within the controlled area 902. For instance, the event detection circuit 920 may predict the age, gender, emotion, sentiment, body language, emotion, and/or gaze direction of a person within a video frame 916(1), and an event 932 based upon the determined attribute information. The event detection circuit 920 may employ the one or more ML models 922(1)-(n) and/or pattern recognition techniques to determine attributes of the people within the controlled area 902 based on the one or more video frames 916(1)-(n).

In some aspects, the event detection circuit 920 may determine an operational status of the video capture devices 908(1)-(n). For example, the event detection circuit 920 may determine whether a camera is offline, obstructed, or partially obstructed. The event detection circuit 920 may further employ the one or more ML models 922(1)-(n) and/or pattern recognition techniques to determine the operational status of the video capture devices 908(1)-(n) based on the one or more video frames 916(1)-(n).

The operator tracking circuit 924 may identify and track activity performed by one or more operators (e.g., security personnel) to determine operator activity information 936. In some aspects, the operator tracking circuit 924 may monitor actions taken by an operator of a monitoring application 934, a management device 910, and/or the event monitoring server 904. For example, the operator tracking circuit 924 may track if an operator has selected to view one or more video frames 916(1)-(n) of one or more particular video capture devices 908(1)-(n). The operator tracking circuit 924 may track if an operator has initiated communications to one or more management devices 910(1)-(n) and/or the authorities. The operator tracking circuit 924 may track if the operator has activated or deactivated an alarm, an alert, a fire prevention system (e.g., a sprinkler system), and/or an evacuation protocol. The operator tracking circuit 924 may track if the operator has initiated opening a door, locking a door, securing an entryway or exit way, providing access via an entryway or exit way, or assigning one or more personnel (e.g., security, repair, customer service, etc.) to a particular location of the controlled area 902.

The event management circuit 918 may recommend security responses to the events 932(1)-(n) and/or the operator activity information 936 via ML model 938(1)(n). For example, the event management circuit 918 may recommend sending a communications (e.g., a notification) to one or more management devices 910(1)-(n) and/or the authorities. The event management circuit 918 may recommend activating or deactivating an alarm, an alert, a fire prevention system (e.g., a sprinkler system), and/or an evacuation protocol. The event management circuit 918 may recommend opening a door, locking a door, securing an entryway or exit way, providing access via an entryway or exit way, or assigning one or more personnel (e.g., security personnel, repair personnel, customer service personnel, etc.) to visit a particular location of the controlled area 902.

In some aspects, the presentation circuit 928 may present a security response determined by the event management circuit 918 via a graphical user interface (GUI) of the monitoring application 934. In some implementations, the presentation circuit 928 may present a GUI object for initiating performance of the response or the event management circuit 918 may initiate performance of security response. For example, in response to an event 932 in the field of view of a particular video capture device 908, the presentation circuit 928 may present a GUI with a GUI object that triggers display of one or more video frames 916 received from the particular video capture device 908. In response to an event 932 in the field of view of a particular video capture device 908, the presentation circuit 928 may present a GUI that displays of one or more video frames 916 received from the particular video capture device 908 via the automation circuit 930. In response to an event 932 in an area of the controlled area 902 associated with a particular security personnel, the presentation circuit 928 may present a GUI with a GUI object that triggers transmission of a notification 940 to the particular security personnel, unmanned aerial vehicles, and/or security robot by the notification circuit 926. In response to an event 932 in an area of the controlled area 902 associated with a particular security personnel, the presentation circuit 928 may transmit a notification 940 to the particular security personnel via the notification circuit 926 and the automation circuit 930. In response to an event 932 in proximity to a door of the controlled area 902, the presentation circuit 928 may present a GUI with a GUI object that locks the door when selected and/or activated. In response to an event 932 in proximity to a door of the controlled area 902, the event management circuit 918 may lock the door via the automation circuit 930.

In some implementations, the presentation circuit 928 may provide a security response determined by the ML model 938 prior to performance by a security or safety response by an operator. For example, upon determination of an event 932 by the event management circuit 918, the presentation circuit 928 may present the security response to an operator or the automation circuit 930 may perform the security response. In some implementations, the operator tracking circuit 924 may track activity of an operator to identify a proposed response of the operator. The event management circuit 918 may compare the proposed response of the operator to the security response recommended by the ML model 938, and recommend the security response as the preferred alternative over the proposed response based on the security response and the proposed response not matching.

The ML model 938 may include a neural network, deep learning network, large language model, decision tree, and/or any another other type of machine learning model described herein. In some aspects, a “neural network” may refer to a mathematical structure taking an object as input and producing another object as output through a set of linear and non-linear operations called layers. Such structures may have parameters which may be tuned through a learning phase to produce a particular output, and are, for instance, a security response. In addition, the ML model 938 may be a model capable of being used on a plurality of different devices having differing processing and memory capabilities. For example, in some aspects, a ML model 938 is a neural network, which may include multiple hidden layers, multiple neurons per layer, and synapses connecting these neurons together. Further, model weights are applied to data passing through the individual layers of the ML model 938 for processing by the individual neurons.

In some implementations, the ML model 938 may include a first sub-model 942 trained using operating procedures for event response and a second sub-model 944 trained using historic events and historic responses to the historic events. In some implementations, the ML model 938 may be a generative adversarial network (GAN). As used herein, in some implementations, a GAN consists of two ML networks (e.g., two neural networks): a generator that creates new data and a discriminator that evaluates the data. Further, the generator and discriminator may work together, with the generator improving its outputs based on the feedback it receives from the discriminator until it generates content that is indistinguishable from real data. In some implementations, the first sub-model 942 may be a discriminator based on operating policies and the second sub-model 944 may be a generator based on historic event and response information, and the first sub-model may be used to train the second sub-model. In some implementations, the ML model 938 may be trained using reinforcement learning and/or a reward model. Further, as described herein, the ML model 938 may be configured to predict security responses to events, and validate security operations performed by operators (e.g., human operators) in response to events. In some implementations, the predicted security responses are considered a dynamic standard operating policy to be presented and followed by operators.

The notification circuit 926 may be configured to send notifications 940(1)-(n) to the management devices 910(1)-(n). In some implementations, the notifications may be transmitted based on security response determined by the ML model 938. In some instances, the notifications 940(1)-(n) may be a visual notification, audible notification, or electronic communication (e.g., text message, email, etc.) to the management devices 910(1)-(n). For example, the ML model 938 may instruct the automation circuit 930 and notification circuit to transmit a response, and/or the content of the notification 940 may be generated by the ML model 938. The presentation circuit 928 may present the security response determined by the ML model 938 and/or present GUI elements resulting from performance of a security response determined by the ML model 938. The automation circuit 930 may facilitate performance of a security response determined by the ML model 938.

### Autonomous Building Security Recommendation Generation Using Machine Learning Models

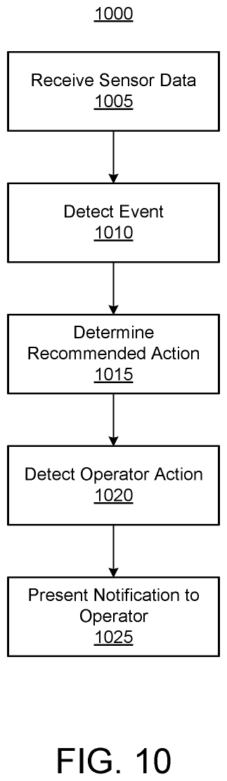

FIG. 10 depicts an example of a method 1000 for autonomous building security recommendation generation using machine learning models, according to an example embodiment. The method 1000 can be performed using various devices and systems described herein, including but not limited to the systems 100, 200, 900, or one or more components thereof. Various aspects of the method 1000 can be implemented using one or more devices or systems that are communicatively coupled with one another, including in client-server, cloud-based, or other networked architectures.

At step 1005, sensor data can be received by the system or one or more processors of the system, such as from one or more sensors included in or coupled with the system. In some implementations, the sensor data may be received from one or more sensors associated with a building or a system within the building. For example, in some instances, the sensors may include one or more of door access sensors, video cameras, audio sensors, motion sensors, and/or any other types of sensors described herein.

At step 1010, one or more events can be detected within the building based on the received sensor data. For example, in some instances, the one or more events may include one or more of a forced door event, a motion sensor trigger, a glass break event, a gunshot event, an access rejection, one or more cameras being in an offline state, one or more cameras being in an out of focus state, a power outage event, a failed device restart process event, a physical altercation event, or any other relevant event that may be responded to be security and/or safety personnel. Detecting the events can include, for example and without limitation, providing the sensor data as input to any one or more rules engines, models, classifiers, heuristics, algorithms, functions, or other operations configured to output an indication of an event responsive to sensor data.

At step 1015, an action (e.g., a recommended action) for an operator to perform can be determined based on the received sensor data and/or the event detected within the building. For example, in some instances, the recommended action may be determined using a machine learning model (e.g., any of the machine learning models described herein) based on the received sensor data and/or the detected event within the building. In some instances, the machine learning model may be trained using a variety of training data. For example, in some implementations, the machine learning model is trained using data retrieved from one or more data sources maintained by an entity associated with the building and/or building system (e.g., a business, manufacturer, or other entity who owns, operates, or otherwise maintains the building and/or building system). For example, in some instances, this training data may comprise historical data associated with the building, the building system, and/or previous responses by operators to various events. This training data may allow for the machine learning model to learn specific information for providing insights regarding potential security and/or safety events and/or responses that are specific to the building and/or building system. In some instances, the training data may further comprises various standard operating procedures and/or regulatory standards associated with the building and/or the building system. In some instances, the training data may further include one or more live data streams from within the building (e.g., received via the building system and/or directly from one or more sensors within the building).

In some implementations, the machine learning model is trained using data retrieved from one or more data source maintained by another entity associated with providing various equipment (e.g., sensors, security system, etc.) for use within the building and/or building system. In some instances, this training data may allow the machine learning model to learn a variety of additional information and/or insights regarding potential security and/or safety events and/or responses based on a larger data pool comprising historical information pertaining to a multitude of buildings, building systems, areas of interest, etc.

It will be appreciated that, in some instances, the training data may be retrieved from both a first entity associated with the building and/or building system and with a second entity associated with providing the various equipment for use within the building and/or building system. This dual training allows for the system (e.g., the machine learning models) to generate accurate insights (e.g., due to the large amount of historical data associated with multiple buildings, building systems, and/or other areas of interest provided by the second entity) that are also specific to the particular building for which those insights are being generated (e.g., due to the building-specific historical data provided by the first entity). Further, in some instances, the training data used to train the machine learning model may be pre-annotated (e.g., by one or more users or automatically via an annotation program) or may be raw data. Additionally, it should be noted that, in some instances, the machine learning model may be trained using exclusively data retrieved from the first and/or second entity, such that the models can be trained without accessing third-party information over the internet. However, in some other instances, the models may further be trained using training data from third parties accessed over the internet. Further, in some instances, the machine learning model may be a generative adversarial network having a first sub-model trained on security standard operating procedures as a generator and a second sub-model trained on prior security events and responses as a discriminator (or vice versa).

In some instances, utilizing a plurality of sensors of differing types and locations may allow for the machine learning models to more accurately determine an appropriate response to a given event. For example, in some instances, the machine learning model may detect one or more events based on first sensor data received from one or more first sensors (e.g., a door latch sensor). However, in some instances, a given event may have multiple potential underlying causes, and thus multiple potential response actions that could be taken. In some instances, additional information received from one or more second sensors (e.g., cameras and/or audio sensors near the door latch sensor) may allow for the machine learning model to differentiate between various causes (e.g., inclement weather blew debris into the door causing it to open, an active shooter entered through the door, the door latch sensor is faulty) to provide differing response recommendations (e.g., dispatch employees to move debris, contact authorities to apprehend active shooter, replace door latch sensor).

In some instances, the system may be configured to determine that one or more follow-up questions regarding the sensor data and/or the detected event would be beneficial for improving the accuracy of the recommended action. Accordingly, in these instances, the system (e.g., utilizing the machine learning models described herein) may be configured to ask the operator the one or more follow-up questions via a notification presented to the operator. For example, in some instances, the follow-up questions may be asked to the operator via a conversational chat interface (e.g., a text-based chat interface, an verbal or audio-based chat interface).

At step 1020, an operator action can be detected. For example, in some instances, the operator action may be detected based on an operator input received via a user interface. In some other instances, the operator action may be detected based on received sensor data received from one or more sensors associated with the building system. For example, if the operator makes a phone call in response to an emergency situation, the system may detect this action either through the phone system itself (e.g., if the phone system is linked into the building system) or through one or more camera feeds showing the operator making a phone call.

In some instances, the system may determine that a target response time associated with one or more detected events has lapsed without an operator action being detected. For example, if a potential safety issue is detected, a target response time may be a minute. However, if no operator response is detected, in some instances, the system may generate and display a notification requesting confirmation that the operator has responded to the potential safety issue (e.g., “please confirm whether you have contacted security”). For example, in some instances, the notification may include a request for confirmation that the determined recommended action is being performed. In some instances, the notification may further include a request for details on how the operator is to the potential safety issue if the operator is not performing the recommended action.

At step 1025, a notification can be presented to the operator. For example, in some instances, the notification may be presented to the operator using one of a display device (e.g., via a graphical user interface) or an audio output device. In some instances, the notification may be presented to the operator via a conversational chat interface (e.g., a text-based chat interface, an verbal or audio-based chat interface).

In some instances, the notification may be presented based on the detected operator action being different from the determined recommended action. For example, in some instances, the system is configured to compare any detected operator action to the recommended action to determine whether the operator (e.g., security or safety personnel) is performing the recommended action or is performing a different response action. In the case that the operator is not performing the recommended action, the notification provided to the operator may include an indication requesting that the operator perform the recommended action in lieu of the action the operator has begun performing.

In some instances, the notification provided to the operator may be based on an experience level of the operator. For example, in some instances, the operator may be signed into the system (e.g., using various login credentials) such that the system is able to recognize the operator for whom the notification is being generated. Similarly, the operator could be recognized based on facial recognition using one or more camera feeds from within the building. In any case, once the operator is identified, the system may determine whether the operator is new to the position or if they are an experienced operator. For example, in some instances, an administrator of the system or a building manager may be able to indicate when an operator has sufficient training to receive less guidance from the system (e.g., that the operator is “experienced”). The system may then generate the notification to the operator according to the experience level.

For example, in some instances, if the operator is inexperienced, the notification may include a full description of the recommended action and may be presented to the operator proactively before the operator begins to take any action. Additionally, if an operator is inexperienced, a subsequent notification may be generated and displayed to the operator upon performance and/or initiation of the “correct” action (i.e., the recommended action) in response to a given event.

Alternatively, if the operator is experienced, the notification may simply be a graphical user interface element (e.g., a color-coded icon, a checkmark, etc.) that is displayed to the operator as a result of the operator performing and/or initiating the recommended action. In some instances, if the operator is experienced and performs the recommended action, the system may not present any notification to the operator regarding the recommended action. In some instances, if the operator is experience, the system may only present the notification to the operator if the system determines that the operator has taken a different action than the recommended action.

It should be appreciated that, in some instances, the machine learning models described herein may further be configured to predict events that have not yet occurred based on the sensor data received from within the building (e.g., using machine learning models trained on historical sensor data leading up to events in the past). For example, if the system determines that several people have begun gathering in a space within the building based on camera feeds from within the building, and the system further determines that people are shouting within that space within the building based on various audio feeds from within the building, the system may predict that a physical altercation is about to begin. Similarly, in some instances, the machine learning models described herein may further be configured to determine or otherwise identify false alarm events and actively reduce false alarms. For example, if operators consistently clear or do not respond to a detected event, the system may generate less notifications pertaining to that type of event or completely cease generating notifications pertaining to that kind of event.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method, comprising:
receiving, by one or more processors, sensor data from one or more sensors associated with a building system;
determining, by the one or more processors using a machine learning model and the sensor data, a recommended action for an operator to perform, the machine learning model trained using training data comprising data retrieved from one or more data sources maintained by at least one of a first entity associated with the building system or a second entity associated with the one or more sensors; and
presenting, by the one or more processors using at least one of a display device or an audio output device, a notification corresponding to the recommended action.

2. The method of claim 1, further comprising:
detecting, by the one or more processors, an operator action; and
comparing, by the one or more processors, the operator action to the recommended action, wherein the notification is presented based on the comparison between the operator action and the recommended action.

3. The method of claim 1, further comprising detecting, by the one or more processors, an operator action responsive to one or more of an operator input received via a user interface or the sensor data received from the one or more sensors associated with the building system.

4. The method of claim 1, further comprising:
determining, by the one or more processors, that an operator action is different than the recommended action; and
providing a notification to a user interface prior to completion of the operator action based on the operator action being different than the recommended action.

5. The method of claim 1, further comprising outputting, by the one or more processors using a user interface, a notification requesting that the operator perform the recommended action in lieu of an operator action detected to be performed by the operator.

6. The method of claim 1, further comprising presenting, by the one or more processors using a conversational chat interface, a notification regarding the recommended action.

7. The method of claim 1, comprising determining, by the one or more processors, the recommended action based on detection of one or more events from the sensor data.

8. The method of claim 1, wherein the sensor data from the one or more sensors includes first sensor data from at least one first sensor and second sensor data from at least one second sensor, and determining the recommended action comprises:
detecting, by the one or more processors, the one or more events based on the first sensor data; and
determining, by the one or more processors using the machine learning model, the recommended action based on the one or more events and the second sensor data.

9. The method of claim 1, wherein determining the recommendation action comprises determining the recommendation action based on one or more events detected from the sensor data, the one or more events comprising one or more of a forced door event, a motion sensor trigger, a glass break event, a gunshot event, an access rejection, one or more cameras being in an offline state, or one or more cameras being in an out of focus state.

10. The method of claim 1, further comprising:
determining, by the one or more processors, that a target response time associated with one or more events has lapsed without an operator action being detected; and
causing, by the one or more processors, presentation of a notification regarding the recommendation action responsive to determining that the target response time has lapsed without the operator action being detected.

11. The method of claim 1, further comprising outputting, by the one or more processors, a request for confirmation that the recommended action is being performed.

12. The method of claim 1, further comprising generating, by the one or more processors, a notification regarding the recommendation action based on an experience level of the operator.

13. The method of claim 1, wherein the one or more sensors comprise one or more of door access sensors, video cameras, audio sensors, or motion sensors.

14. The method of claim 1, wherein the training data comprises at least one of historical data, one or more standard operating procedures, one or more regulatory standards, and one or more live data streams associated with the at least one of the first entity or the second entity.

15. The method of claim 1, wherein the machine learning model comprises a plurality sub-models including a generator model configured using standard operating procedure information and a discriminator model configured using historical operator action information.

16. The method of claim 1, wherein the machine learning model comprises at least one of a generative adversarial network, a deep learning network, a language model, or a neural network.

17. The method of claim 1, wherein presenting the notification comprises presenting a graphical user interface element resulting from performance and/or initiation of the recommended action.

18. A system, comprising:
one or more processors to:
receive sensor data from one or more sensors associated with a building system;
determine, using a neural network and the sensor data, a recommended action for an operator to perform, the neural network trained using training data comprising data retrieved from one or more data sources maintained by at least one of a first entity associated with the building system or a second entity associated with the one or more sensors; and
present, using at least one of a display device or an audio output device, a notification corresponding to the recommended action.

19. The system of claim 18, wherein the neural network comprises at least one of an encoder-decoder model, a language model, or a generative adversarial network.

20. The system of claim 18, wherein the one or more processors are to:
detect an operator action based on one or more inputs provided to a user interface subsequent to reception of the sensor data;
compare the operator action to the recommended action to determine that the operator action is different from the recommendation action; and
present the notification, prior to completion of the operator action, via a conversational chat interface associated with the user interface, to indicate a request to perform the recommendation action.
